(19) United States
(12) Patent Application Publication
(10) Pub. No.: US 2004/0161151 A1
(43) Pub. Date: Aug. 19, 2004

(54) On-line handwritten character pattern recognizing and editing apparatus and method, and recording medium storing computer-executable program for realizing the method

(75) Inventors: Naomi Iwayama, Kawasaki (JP); Hiroshi Tanaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/352,006

(22) Filed: Jan. 28, 2003

(30) Foreign Application Priority Data
Apr. 16, 2002 (JP) 2002-113847

(51) Int. Cl. G06K 9/00

(52) U.S. Cl. 382/187

(57) ABSTRACT

An on-line handwritten character pattern recognizing and editing method for recognizing and editing an on-line handwritten character pattern includes: obtaining and recognizing an on-line handwritten character pattern; outputting a recognition result character string and editing information in a specified region; storing the editing information as recognition result editing information data on the basis of the specified region; specifying a region for editing the recognition result character string; and reading the recognition result editing information data stored in a region corresponding to the region to be edited and editing, wherein an interface displaying no character frames is used for obtaining the on-line handwritten character pattern, and an interface displaying character frames is used for editing the on-line handwritten character pattern.

### BACKGROUND OF THE INVENTION

1. Field of the Invention

The present invention relates to an on-line handwritten character pattern recognizing and editing apparatus and method. In particular, the present invention relates to an on-line handwritten character pattern recognizing and editing apparatus and method for converting an on-line handwritten character pattern, written without any constraint of placing one character in one character frame, to a character string.

2. Description of the Related Art

With the recent rapid advancement of computer technology, a number of mobile terminals and the like handling handwritten characters are being developed. A conventional mobile terminal and the like handling handwritten characters generally have a configuration in which character frames for inputting handwritten characters in input regions are provided, and one handwritten character is placed in one character frame.

However, particularly, in the case of scratching characters as in a memo, it is required to input handwritten characters without being conscious of character frames. Recently, there is a developed technique of converting an on-line handwritten character pattern, written without any constraint of placing one character in one character frame, to a character string.

According to the technique of converting an on-line handwritten character pattern, written without any constraint of placing one character in one character frame, to a character string, an input handwritten character pattern is cut out to a region on one character basis, and characters are recognized on the basis of the cut-out character region. Therefore, regarding an error in a recognition result, two kinds are considered: an error in cutting out a region on one character basis and a character recognition error with respect to the cut-out region. Various editing methods have been proposed with respect to such two kinds of recognition errors.

For example, JP 9(1997)-218922 A discloses a method for editing a recognition result caused by an error in cutting out a region on one character basis. According to the method disclosed by JP 9(1997)-218922 A, there is provided means for displaying an image of a partial pattern corresponding to a recognition result to be amended and changing the cut-out region with respect to the image, whereby the changed cut-out region is newly recognized.

As described above, according to the editing of the result obtained by converting an on-line handwritten character pattern, written without any constraint of placing one character in one character frame, to a character string, it is required not only to edit a recognition result caused by an error in cutting out to a region on one character basis, but also to edit a recognition result caused by a character recognition error with respect to the cut-out region. Furthermore, in the case where a handwritten character pattern is not included in candidates of the recognition result, it is required to input the handwritten character pattern again. Particularly, in the case of inputting the handwritten character pattern again, it is required to minimize a recognition error.

According to the method disclosed by JP 9(1997)-218922 A, when a recognition result caused by an error in cutting out to a region on one character basis is edited, a cut-out region is changed with respect to an image. Accordingly, this method can handle the case where one character is divided into three or more or in the case where three or more characters are cut out as one character. However, an operation of changing a cut-out region is not easy for a user who operates it for the first time.

Furthermore, an editing method for a character recognition error with respect to a cut-out region is not disclosed. Therefore, a user is required to perform an editing operation after determining whether a recognition error is caused by an error in cutting out to a region on one character basis or by a character recognition error with respect to the cut-out region. Furthermore, an editing method in inputting a handwritten character pattern again is not disclosed.

### SUMMARY OF THE INVENTION

Therefore, with the foregoing in mind, it is an object of the present invention to provide an on-line handwritten character pattern recognizing and editing apparatus and method capable of performing an editing operation through an interface that is easy to use in the same way as in character recognition software using character frames, in which an input pattern is obtained through an interface displaying no character frames and a recognition result is edited through an interface displaying character frames, thereby eliminating the constraint of character frames for inputting and enabling the character frames to be used for editing.

In order to achieve the above-mentioned object, an on-line handwritten character pattern recognizing and editing apparatus of the present invention recognizes an on-line handwritten character pattern input by a user and outputs and edits a recognition result in a specified region. The apparatus includes: a pattern obtaining part for obtaining the on-line handwritten character pattern; a pattern recognizing part for recognizing the obtained on-line handwritten character pattern, and outputting a recognition result character string and editing information for editing a recognition result; an output region instruction receiving part for receiving information on specifying a region for outputting the recognition result character string; a recognition result transmitting part for transmitting the recognition result character string to the specified region for outputting; a recognition result editing information storing part for storing the editing information as recognition result editing information data on a basis of the specified region for outputting; an editing region instruction receiving part for receiving information on specifying a region for editing the recognition result character string; a recognition result editing information obtaining part for reading the recognition result editing information data stored in the region for outputting corresponding to the specified region for editing; and a recognition result editing part for editing the recognition result character string based on the read recognition result editing information data, wherein the pattern obtaining part obtains the on-line handwritten character pattern using an interface that displays no character frames, and the recognition result editing part edits the recognition result character string using an interface that displays character frames.

Because of the above configuration, a conventional editing interface with character frames can be used for a handwritten character pattern without any constraint of character frames, and a recognition result can be edited efficiently.

Furthermore, in the on-line handwritten character pattern recognizing and editing apparatus of the present invention, it is preferable that the recognition result editing information storing part stores a candidate character group with respect to each character of the recognition result character string as the recognition result editing information data. This is because a candidate character with a high pattern evaluation value can be selected easily.

Furthermore, in the on-line handwritten character pattern recognizing and editing apparatus of the present invention, it is preferable that the recognition result editing information storing part stores one or a plurality of character region candidates and a candidate character group with respect to the character region candidates as the recognition result editing information data. According to this configuration, in the case where an error of a recognition result is caused by an error in cutting out a character region, the recognition result can be edited by preparing an interface for dividing and combining a character region.

Furthermore, in the on-line handwritten character pattern recognizing and editing apparatus of the present invention, it is preferable that the recognition result editing part includes a region for a character displayed as a recognition result with respect to one character frame, and displays, as a recognition candidate, a candidate character in a character cut-out region different from the displayed recognition result. According to this configuration, even in the case where an error of a recognition result is caused by an error in cutting out a character region, a recognition result can be edited by a simple selection operation.

Furthermore, in the on-line handwritten character pattern recognizing and editing apparatus of the present invention, it is preferable that when the candidate character in the character cut-out region different from the displayed recognition result with respect to one character frame is focused, the recognition result editing part discriminates and displays a region in a character frame corresponding to character cut-out of the candidate character. According to this configuration, in the case where the currently focused candidate character is different from the displayed character cut-out, a character string to be displayed as a result of selection is known.

Furthermore, in the on-line handwritten character pattern recognizing and editing apparatus of the present invention, it is preferable that the recognition result editing information storing part stores the on-line handwritten character pattern input by the user as the recognition result editing information data. According to this configuration, when the recognition result character string is edited, a handwritten character pattern used for recognition can be confirmed.

Alternatively, the character region candidate and the on-line handwritten character pattern cut-out corresponding thereto may be stored. According to this configuration, in the case where a user determines a recognition result, the on-line handwritten character pattern recognizing and editing apparatus learns the on-line handwritten character pattern cut-out corresponding to the determined character, and reflects the leaned result to next recognition of a handwritten character pattern, thereby enhancing recognition accuracy.

Furthermore, in the on-line handwritten character pattern recognizing and editing apparatus of the present invention, it is preferable that the recognition result editing information storing part stores, as the recognition result editing information data, a character division candidate and the on-line handwritten character pattern cut-out corresponding to the character division candidate. According to this configuration, in the case where a recognition result is edited, the recognition result can be edited easily by dividing and combining.

Furthermore, it is preferable that the on-line handwritten character pattern recognizing and editing apparatus of the present invention further includes a recognition range selecting part for selecting a range to be recognized in the on-line handwritten character pattern, wherein the pattern obtaining part obtains the on-line handwritten character pattern in a range selected by the recognition range selecting part. According to this configuration, only a required portion needs to be subjected to pattern recognition.

Furthermore, it is preferable that the on-line handwritten character pattern recognizing and editing apparatus of the present invention includes an output region determining part for determining a region for outputting a pattern recognition result based on a region where the on-line handwritten character pattern is input, in place of the output region instruction receiving part. According to this configuration, a user is not required to be conscious of an output region.

Furthermore, it is preferable that the on-line handwritten character pattern recognizing and editing apparatus of the present invention further includes: a region information obtaining part for, in a case of receiving an instruction of an output region and an editing region in the output region instruction receiving part and the editing region instruction receiving part, obtaining information peculiar to the output region and the editing region; and a region information setting part for setting information peculiar to the output region and the editing region obtained in the region information obtaining part with respect to the pattern recognizing part and the recognition result editing part. According to this configuration, a character pattern to be matched can be narrowed down, whereby on-line handwritten character pattern recognition can be performed with higher accuracy.

Furthermore, the present invention is characterized by a recording medium storing software for executing the function of the above-mentioned on-line handwritten character pattern recognizing and editing apparatus as processing operations of a computer. More specifically, the present invention is characterized by an on-line handwritten character pattern recognizing and editing method for recognizing an on-line handwritten character pattern input by a user and outputting and editing a recognition result in a specified region. The method includes: obtaining the on-line handwritten character pattern; recognizing the obtained on-line handwritten character pattern, and outputting a recognition result character string and editing information for editing a recognition result; specifying a region for outputting the recognition result character string; transmitting the recognition result character string to the specified region for outputting; storing the editing information as recognition result editing information data on a basis of the specified region for outputting; specifying a region for editing the recognition result character string; reading the recognition result editing information data stored in the region for outputting corresponding to the specified region for editing; and editing the recognition result character string based on the read recognition result editing information data, wherein, in the process of obtaining the on-line handwritten character pattern, the on-line handwritten character pattern is obtained using an interface that displays no character frames, and in the process of editing the on-line handwritten character pattern, the recognition result character string is edited using an interface that displays character frames. The present invention is also characterized by a recording medium storing a computer-executable program for realizing the above processes of the method.

According to the above configuration, by loading the program onto a computer for execution, a conventional editing interface with character frames can be used for a handwritten character pattern without any constraint of character frames, and an on-line handwritten character pattern recognizing and editing apparatus capable of efficiently editing a recognition result can be realized.

These and other advantages of the present invention will become apparent to those skilled in the art upon reading and understanding the following detailed description with reference to the accompanying figures.

### BRIEF DESCRIPTION OF THE DRAWINGS

FIG. 1 shows a configuration of an on-line handwritten character pattern recognizing and editing apparatus of an embodiment according to the present invention.

FIG. 2 illustrates a handwritten character input pattern in the on-line handwritten character pattern recognizing and editing apparatus of the embodiment according to the present invention.

FIG. 3 illustrates a pattern recognition result in the on-line handwritten character pattern recognizing and editing apparatus of the embodiment according to the present invention.

FIG. 4 shows a configuration of the on-line handwritten character pattern recognizing and editing apparatus of the embodiment according to the present invention.

FIG. 5 illustrates an output region display in the on-line handwritten character pattern recognizing and editing apparatus of the embodiment according to the present invention.

FIG. 6 illustrates an editing interface in the on-line handwritten character pattern recognizing and editing apparatus of the embodiment according to the present invention.

FIG. 7 illustrates a handwritten character input pattern in the on-line handwritten character pattern recognizing and editing apparatus of the embodiment according to the present invention.

FIG. 8 illustrates a pattern recognition result in the on-line handwritten character pattern recognizing and editing apparatus of the embodiment according to the present invention.

FIG. 9 illustrates an editing interface in the on-line handwritten character pattern recognizing and editing apparatus of the embodiment according to the present invention.

FIG. 10 illustrates an editing interface in the on-line handwritten character pattern recognizing and editing apparatus of the embodiment according to the present invention.

FIG. 11 illustrates the on-line handwritten character pattern recognizing and editing apparatus of the embodiment according to the present invention.

FIG. 12 illustrates the selection of a recognition range in the on-line handwritten character pattern recognizing and editing apparatus of the embodiment according to the present invention.

FIG. 13 shows a configuration of the on-line handwritten character pattern recognizing and editing apparatus of the embodiment according to the present invention.

FIG. 14 shows a flow diagram of processing in the on-line handwritten character pattern recognizing and editing apparatus of the embodiment according to the present invention.

FIG. 15 illustrates a computer environment related to recording media.

### DESCRIPTION OF THE PREFERRED EMBODIMENTS

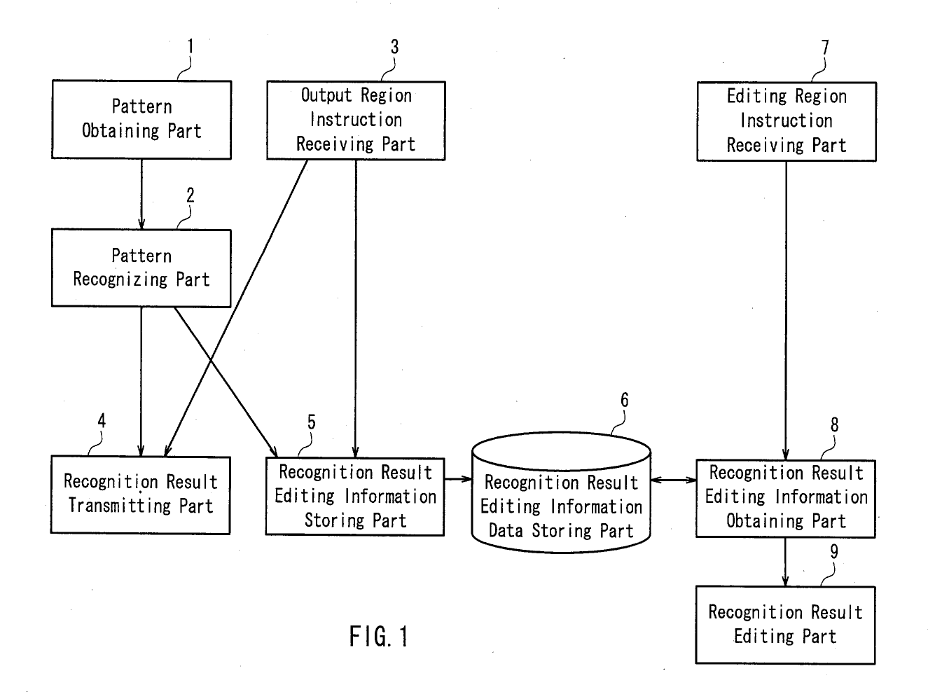

Hereinafter, the pattern recognizing apparatus of an embodiment according to the present invention will be described with reference to the drawings. FIG. 1 shows a configuration of a pattern recognizing apparatus of the embodiment according to the present invention.

In FIG. 1, reference numeral 1 denotes a pattern obtaining part for obtaining a handwritten character pattern input through a handwritten character input part of a pen input type or the like, and 2 denotes a pattern recognizing part for recognizing the handwritten character pattern thus obtained.

Reference numeral 3 denotes an output region instruction receiving part for receiving a user's instruction specifying a region to output and display a recognition result, and 4 denotes a recognition result transmitting part for transmitting the recognition result in the pattern recognizing part 2 so as to display it in the region specified in accordance with the instruction received by the output region instruction receiving part 2.

Reference numeral 5 denotes a recognition result editing information storing part for storing recognition result editing information data in a recognition result editing information data storing part 6, 7 denotes an editing region instruction receiving part for receiving a user's instruction specifying a region to edit the recognition result, 8 denotes a recognition result editing information obtaining part for obtaining the recognition result editing information data, and 9 denotes a recognition result editing part for editing the recognition result.

In FIG. 1, first, the pattern obtaining part 1 obtains an on-line handwritten character pattern to be recognized. The handwritten character pattern to be obtained may be a previously input handwritten character pattern or may be a handwritten character pattern input in real time through a display-integrated tablet. The obtained handwritten character pattern is sent to the pattern recognizing part 2.

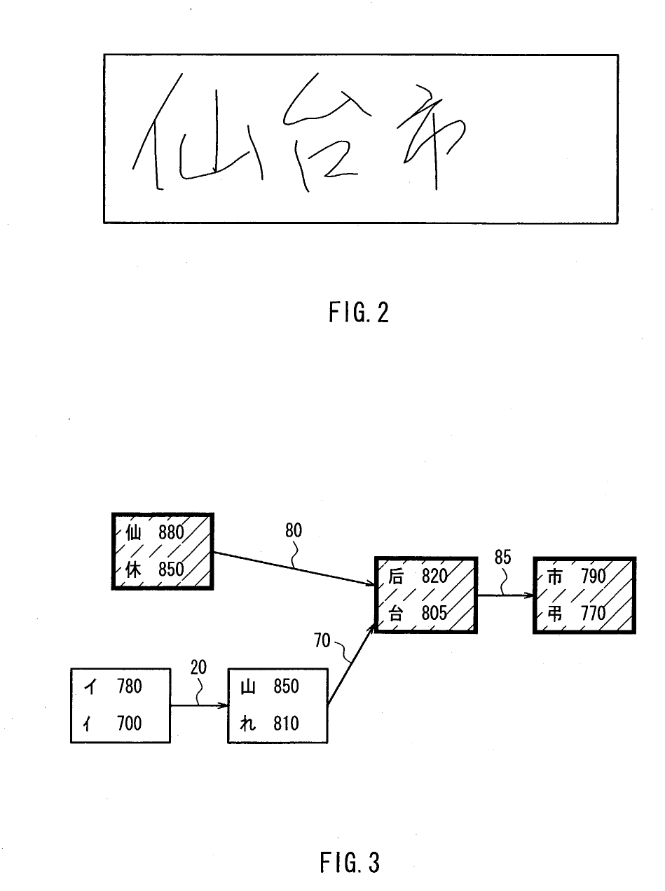

In Embodiment 1, the case will be described where a handwritten character string “ [symbol] (Sendai-shi)” as shown in FIG. 2 is obtained as a handwritten character pattern. In the pattern recognizing part 2, the input handwritten character pattern is divided into segments to be constituent elements. Then, a region on one character basis is determined based on the divided segments, and the input handwritten character pattern is matched with a dictionary for pattern recognition on the basis of the determined character region. A recognition candidate character and a pattern evaluation value on the basis of the recognition candidate character are output.

For extracting the recognition candidate character, any recognition engine such as a generally used OCR recognition engine, an on-line recognition engine, and the like may be used. Furthermore, there is no particular limit to a method for calculating a pattern evaluation value. For example, a distance between the input handwritten character pattern and a pattern in the dictionary for pattern recognition may be calculated, or calculation may be performed based on feature points.

FIG. 3 shows an example of a recognition result in the case where the handwritten character string “ [symbol] (Sendai-shi)” shown in FIG. 2 is input as a handwritten character pattern. In FIG. 3, each recognition candidate node is a recognition candidate character group with respect to the determined character region. An arrow connecting a recognition candidate node to another recognition candidate node represents a recognition candidate path representing the relationship between the determined character region and an adjacent character region. Furthermore, a number above each arrow represents a connection evaluation value when a recognition candidate path is determined. As the number is larger, the possibility of a recognition candidate path is higher.

Furthermore, a number displayed on the side of each recognition candidate character represents a pattern evaluation value of each recognition candidate character. As the number is larger, the possibility of a recognition character is higher.

A validity evaluation value as a character string is calculated based on the connection evaluation value and the pattern evaluation value with reference to a context dictionary or the like with respect to all the recognition candidate paths tracing from the leading recognition candidate node to the trailing recognition candidate node. A character string with the highest validity evaluation value is determined as a recognition result character string.

The recognition result in the pattern recognizing part 2 is transmitted to the recognition result transmitting part 4, and recognition result editing information data used for editing after recognition is transmitted to the recognition result editing information storing part 5. The recognition result editing information data will be described later.

Next, the output region instruction receiving part 3 receives information on a region for outputting a recognition candidate character selected and specified by a user through pen touch or the like. The information on the output region received in the output region instruction receiving part 3 is transmitted to the recognition result transmitting part 4 and the recognition result editing information storing part 5, respectively.

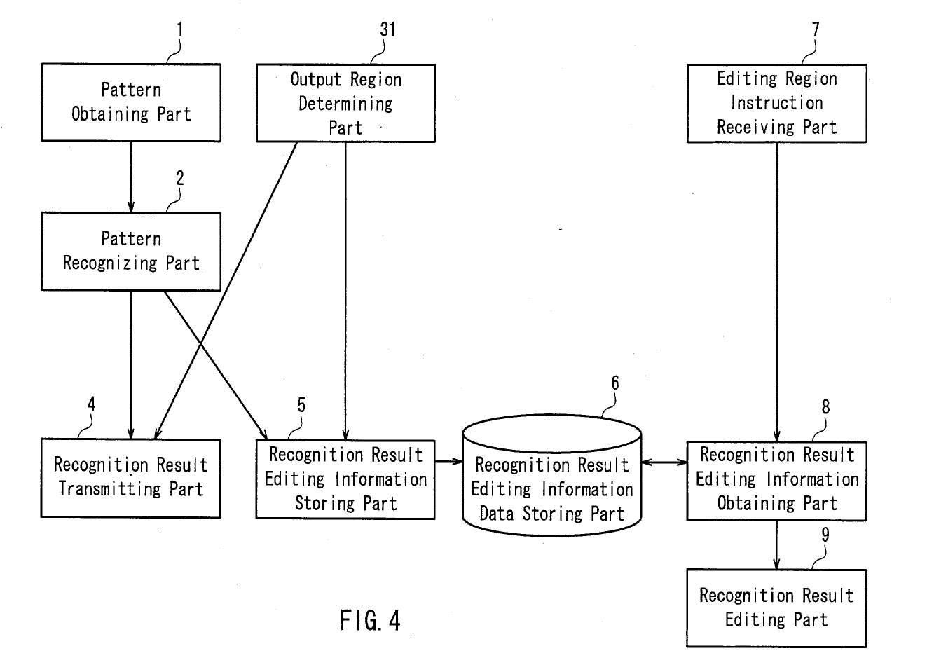

Needless to say, an output region determining part 31 for automatically determining an output region or the like may be provided instead of the output region instruction receiving part 3. FIG. 4 shows the configuration in this case. The output region determining part 31 determines an output region for transmitting a recognition result regarding a handwritten character pattern from a position where the user has input the handwritten character pattern, whereby the recognition result is transmitted to the region determined by the output region determining part 31.

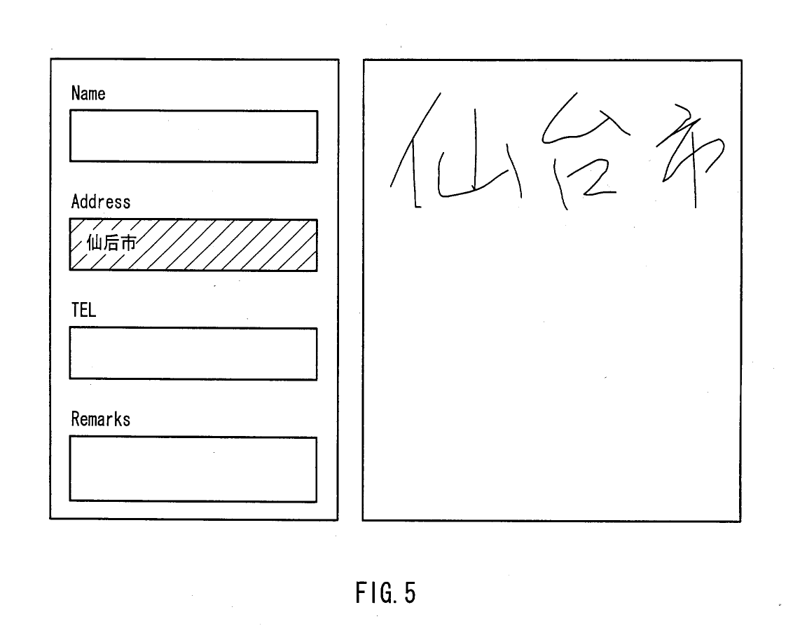

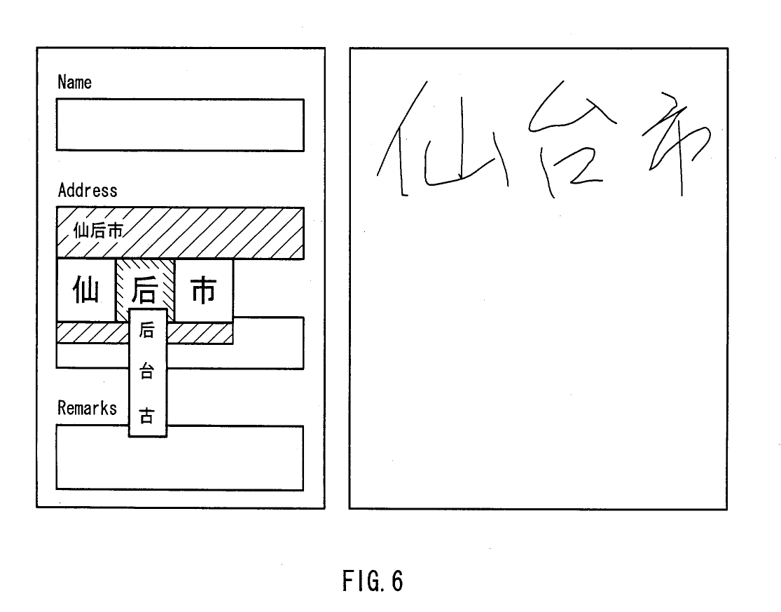

The recognition result transmitting part 4 transmits the recognition result in the pattern recognizing part 2 to the specified output region. FIG. 5 illustrates a state where the recognition result has been transmitted to the output region. FIG. 5 shows a state of a display output in the case where output regions are classified based on the category, the input handwritten character pattern includes the contents regarding an “address”, and the “address” is selected and specified as the output region.

Furthermore, the recognition result editing information storing part 5 associates information required for editing the recognition result with the output region received in the output region instruction receiving part 3, and stores the information in the recognition result editing information data storing part 6.

Herein, it is desired that, as the “recognition result editing information data”, a recognition candidate character group with respect to each character of a recognition result character string is stored for the following reason. Even if an erroneous recognition result is obtained, a correct character is likely to be included in a recognition candidate character group, and it is possible to edit erroneous recognition by selecting another recognition candidate character.

Furthermore, it is desirable that, as the “recognition result editing information data”, a character region candidate and a candidate character group with respect to each character region candidate is stored for the following reason. In the case where an error of a recognition result is caused by an error in cutting out to a character region, a recognition result can be edited by preparing an interface of dividing or combining a character region.

Furthermore, it is also desired, as the “recognition result editing information data”, an on-line handwritten character pattern itself is stored for the following reason. When a recognition result character string is edited, the handwritten character pattern used for recognition can be confirmed.

Furthermore, it is also desired that, as the “recognition result editing information data”, a character region candidate and an on-line handwritten character pattern cut-out corresponding to the character region candidate are stored for the following reason. In the case where a user determines a recognition result, the on-line handwritten character pattern recognizing and editing apparatus learns the on-line handwritten character pattern cut-out corresponding to the determined character, and reflects the learned result to next recognition of a handwritten character pattern, thereby enhancing recognition accuracy.

Furthermore, it is also desired that, as the “recognition result editing information data”, a character division candidate and an on-line handwritten character pattern cut-out corresponding to the character division candidate are stored for the following reason. During editing of the recognition result, the recognition result can be edited easily by dividing or combining characters.

Next, the editing region instruction receiving part 7 receives information on an editing region selected and specified by a user through pen touch or the like. In the case where an editing region is selected and specified, the recognition result editing information obtaining part 8 reads recognition result editing information data corresponding to the selected and specified editing region stored in the recognition result editing information data storing part 6, and sets the read recognition result editing information data at an editing interface.

The recognition result editing part 9 is capable of performing editing by using the editing interface at which the recognition result editing information data with respect to the selected and specified editing region is set. FIG. 6 illustrates a state where the editing interface is selected and specified to be displayed. In FIG. 6, a character frame is set with respect to the recognition result, and by selecting the character frame with a mouse or the like, a recognition candidate character group is displayed in the decreasing order of a pattern evaluation value in a configuration as in a pull-down menu.

The editing interface functions as an interface for displaying character frames. More specifically, although a user inputs a handwritten character pattern without being conscious of character frames, higher recognition accuracy can be obtained when the recognition result is edited.

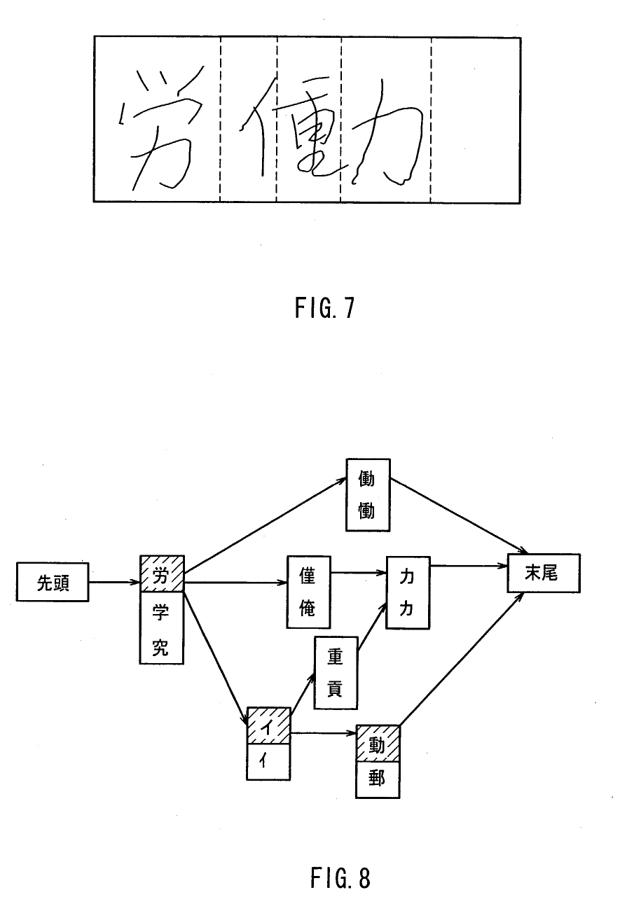

For example, as shown in FIG. 7, when “ [symbol] (Roudouryoku)” is input as a handwritten character pattern, the result recognized without character frames is as shown in FIG. 8. More specifically, there is a high possibility that the second character “ [symbol] ”, in particular, may be recognized as two or three characters instead of one character, depending upon the handwritten character pattern. Therefore, FIG. 8 shows recognition candidate paths and recognition candidate characters in each recognition candidate node including such a possibility.

A validity evaluation value as a character string is calculated based on a connection evaluation value and a pattern evaluation value. A character string with the highest validity evaluation value is selected as a recognition result character string. It is assumed to be “ [symbol] ”.

In this case, when the first character “ [symbol] ” is selected by a mouse or the like in the editing region (output region), operation items and another candidate character group are displayed in a configuration of a pull-down menu or the like. A user can select either one of them.

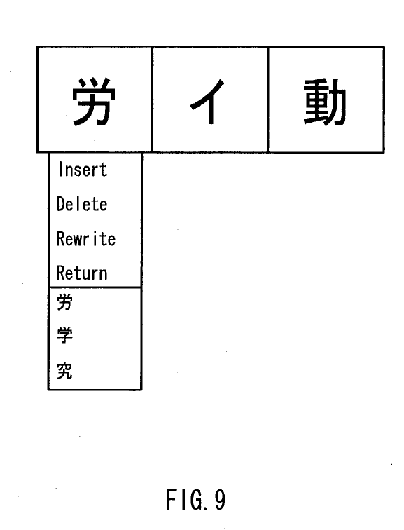

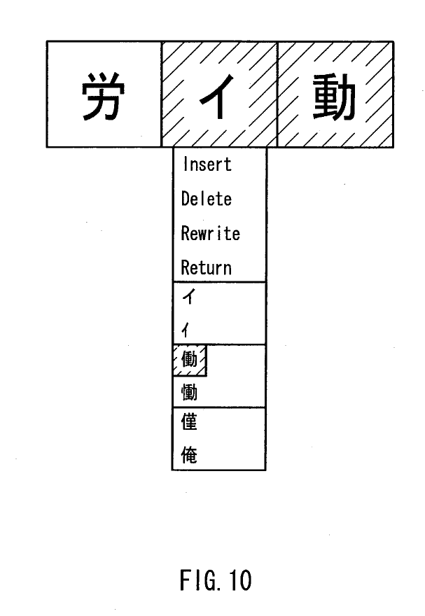

On the other hand, when the second character “ [symbol] ” is selected by a mouse or the like in the editing region (output region), operation items and other candidate character groups are displayed in a pull-down menu or the like in a portion where “ [symbol] ” is displayed as shown in FIG. 10. Unlike FIG. 9, there are a plurality of recognition candidate paths, so that all the recognition candidate paths are displayed in the decreasing order of a validity evaluation value in a pull-down menu.

Needless to say, the editing method in the editing region is not limited to the above-mentioned method. For example, an editing interface may be used, which dynamically changes a recognition candidate character by moving a character frame with a mouse or the like.

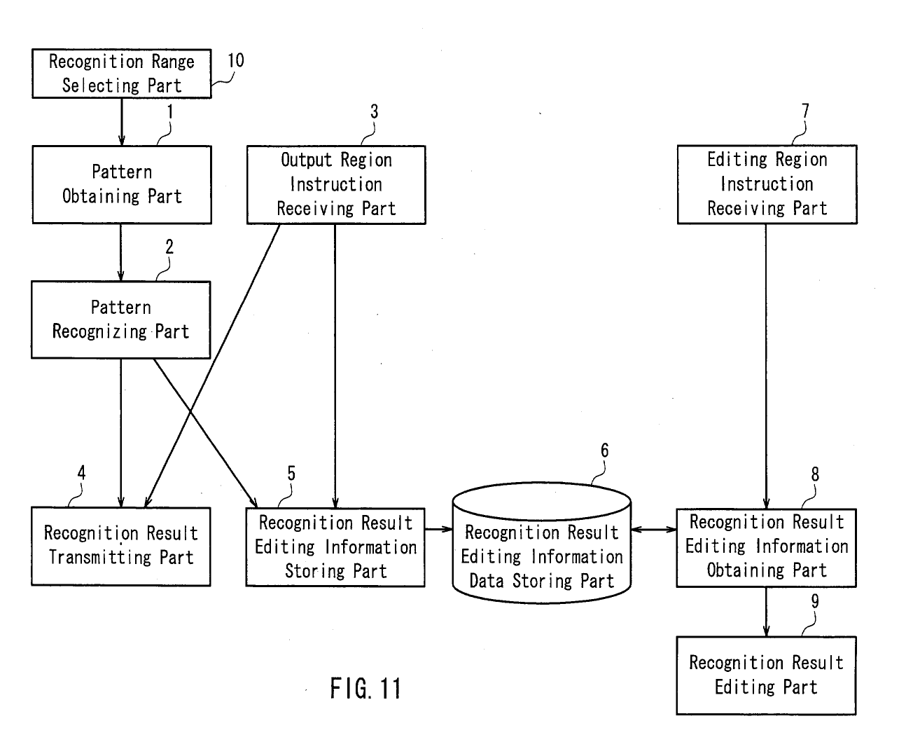

Furthermore, in order to efficiently recognize a handwritten character pattern without character frames, a configuration including a recognition range selecting part 10 for selecting a recognition range is also considered. FIG. 11 shows a configuration in this case.

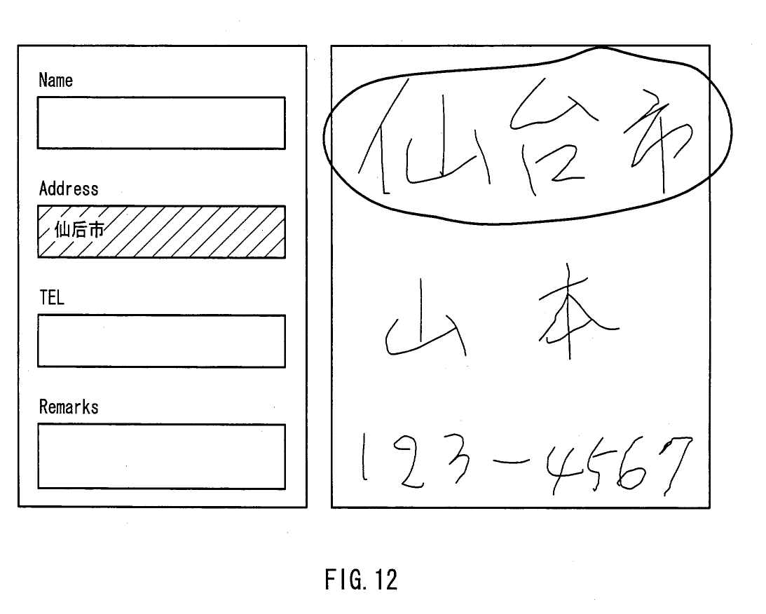

In FIG. 11, the recognition range selecting part 10 is used for specify a range of a handwritten character pattern to be recognized, and a handwritten character pattern in the specified range is obtained. Therefore, a pattern recognition result only in the selected range is transmitted to the specified output region. In an example shown in FIG. 12, only a portion of the handwritten character pattern “ [symbol] (Sendai-shi)” present in a region surrounded by a region specifying line is subjected to pattern recognition, and displayed in the output region.

In the present embodiment, the output region and the editing region are set so as to be previously selected by a user. However, it is also considered that information peculiar to such regions is used for recognizing a character pattern.

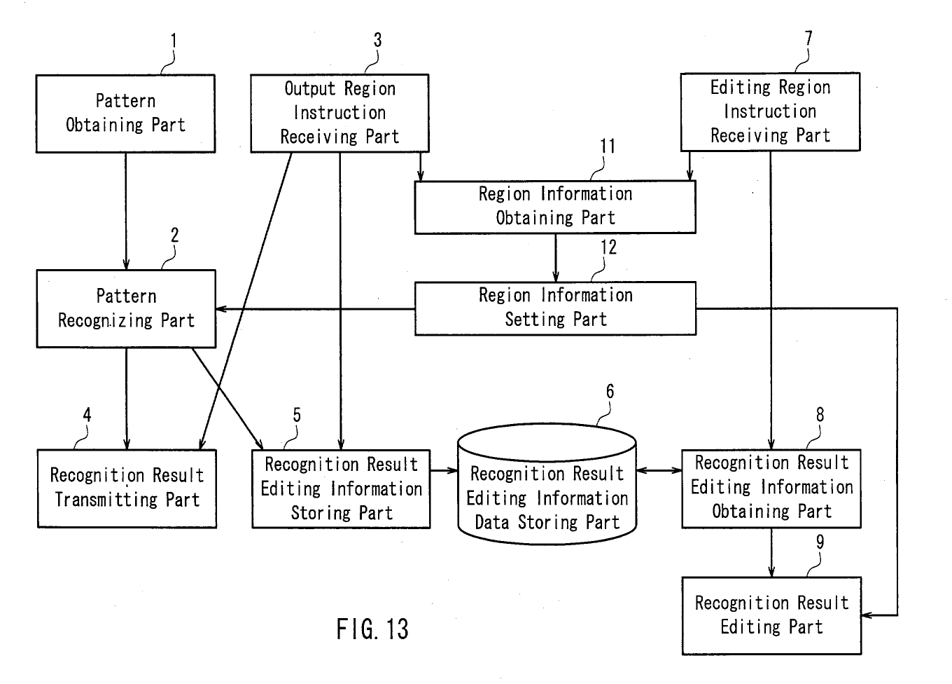

More specifically, as shown in FIG. 13, a region information obtaining part 11 and a region information setting part 12 are provided, and the region information obtaining part 11 obtains, from regions selected and specified by the output region instruction receiving part 3 and the editing region instruction receiving part 7, information peculiar to the regions. An example thereof includes information indicating that only alphanumeric characters are input to (output from) the regions.

Furthermore, the region information setting part 12 sets the information obtained in the region information obtaining part 11 in the pattern recognizing part 2 and the recognition result editing part 9. Because of this, the information peculiar to the regions can be set in the pattern recognizing part 2. For example, in the case of the regions in which only alphanumeric characters are input/output only need to be matched with alphanumeric character patterns. Therefore, recognition accuracy can be enhanced further. Furthermore, by setting the information peculiar to the regions at the editing interface, the accuracy for new-recognition during editing can also be enhanced.

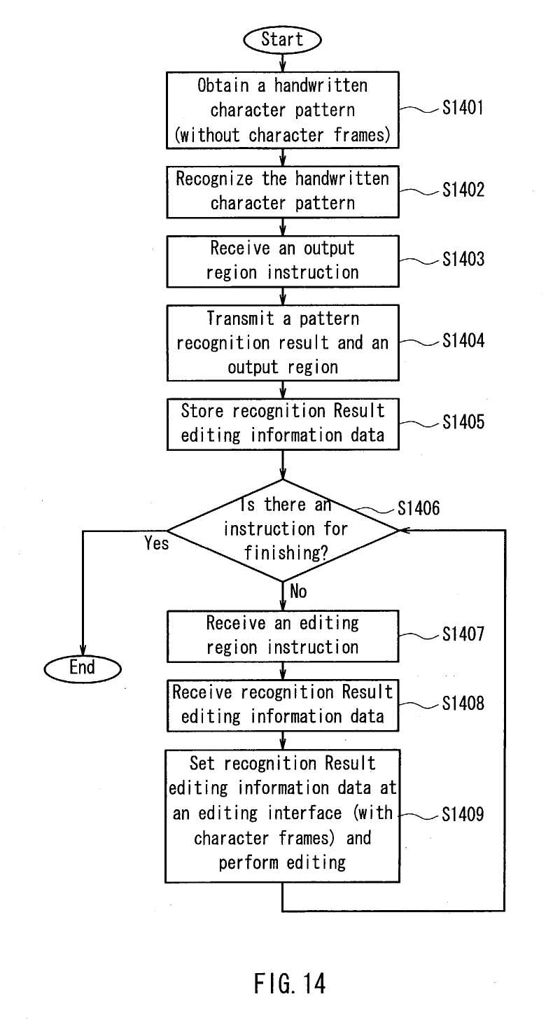

Next, a processing flow of a program for realizing the on-line handwritten character pattern recognizing and editing apparatus of the embodiment according to the present invention will be described. FIG. 14 is a flow diagram showing the on-line handwritten character pattern recognizing and editing apparatus of the embodiment according to the present invention.

In FIG. 14, first, an on-line handwritten character pattern (without character frames) input by a user is obtained (Operation 1401), and the obtained handwritten character pattern is subjected to pattern recognition (Operation 1402).

When an output region instruction input by the user is received (Operation 1403), a pattern recognition result is transmitted to the specified output region (Operation 1404). Then, information required for an editing operation after the pattern recognition is associated with the output region, and stored as recognition result editing information data (Operation 1405).

Herein, the presence/absence of an instruction for finishing the on-line handwritten character pattern recognizing and editing processing is confirmed (Operation 1406), and if there is such an instruction (Operation 1406: Yes), processing is finished.

If there is no such instruction (Operation 1406: No), an instruction of an editing region by the user is received (Operation 1407). Recognition result editing information data for the output region corresponding to the editing region is read (Operation 1408) and set at the editing interface, whereby an editing operation is performed (Operation 1409).

As described above, according to the present embodiment, a handwritten character pattern input at an arbitrary timing is obtained, and a recognition result of the obtained handwritten character pattern is transmitted to the specified output region. Simultaneously, recognition result editing information data is associated with the output region and stored. When an instruction for editing is given, the recognition result editing information data corresponding to the specified editing region is set at the editing interface with character frames and edited. Thus, even regarding a handwritten character pattern without any constraint of character frames, an editing interface with the same character frames as those in a conventional example can be used, and a recognition result can be edited efficiently.

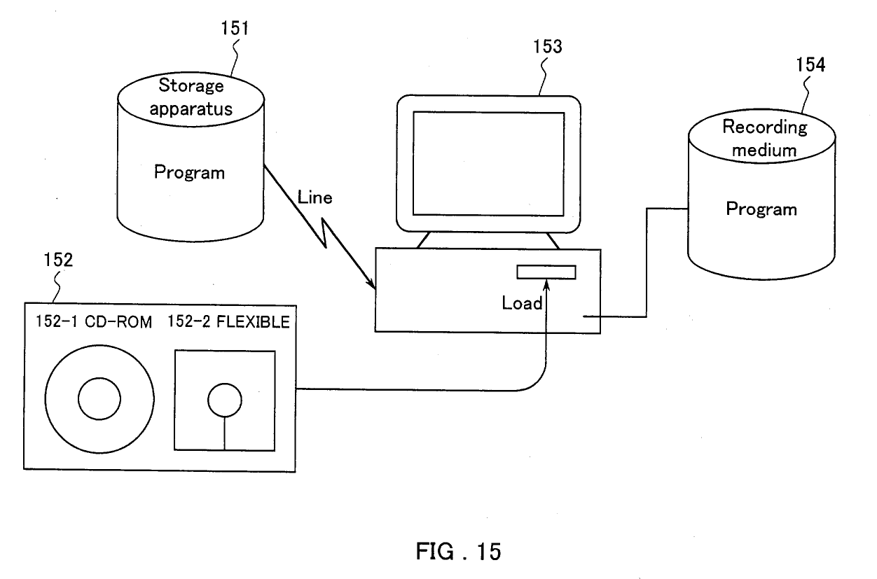

A program for realizing the on-line handwritten character pattern recognizing and editing apparatus of the embodiment according to the present invention may be stored not only in a portable recording medium 152 such as a CD-ROM 152-1 and a flexible disk 152-2, but also in another storage apparatus 151 provided at the end of a communication line and a recording medium 154 such as a hard disk and a RAM of a computer 153, as shown in FIG. 15. In execution, the program is loaded and executed on a main memory.

Furthermore, recognition result editing information data and the like generated by the on-line handwritten character pattern recognizing and editing apparatus of the embodiment according to the present invention may also be stored not only in a portable recording medium 152 such as a CD-ROM 152-1 and a flexible disk 152-2, but also in another storage apparatus 151 provided at the end of a communication line and a recording medium 154 such as a hard disk and a RAM of a computer 153, as shown in FIG. 15. For example, the data is read by a computer 153 using the on-line handwritten character pattern recognizing and editing apparatus according to the present invention.

As described above, according to the on-line handwritten character pattern recognizing and editing apparatus and method according to the present invention, a handwritten character pattern input at an arbitrary timing is obtained, and a recognition result of the obtained handwritten character pattern is transmitted to a specified output region. Simultaneously, recognition result editing information data is associated with the output region and stored. When an instruction for editing is given, the recognition result editing information data corresponding to the specified editing region is set at an editing interface with character frames and editing is performed. Thus, even regarding a handwritten character pattern without any constraint of character frames, an editing interface with the same character frames as those in a conventional example can be used, and a recognition result can be edited efficiently.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An on-line handwritten character pattern recognizing and editing apparatus for recognizing an on-line handwritten character pattern input by a user and outputting and editing a recognition result in a specified region, the apparatus comprising:
a pattern obtaining part for obtaining the on-line handwritten character pattern;
a pattern recognizing part for recognizing the obtained on-line handwritten character pattern, and outputting a recognition result character string and editing information for editing a recognition result;
an output region instruction receiving part for receiving information on specifying a region for outputting the recognition result character string;
a recognition result transmitting part for transmitting the recognition result character string to the specified region for outputting;
a recognition result editing information storing part for storing the editing information as recognition result editing information data on a basis of the specified region for outputting;
an editing region instruction receiving part for receiving information on specifying a region for editing the recognition result character string;
a recognition result editing information obtaining part for reading the recognition result editing information data stored in the region for outputting corresponding to the specified region for editing; and
a recognition result editing part for editing the recognition result character string based on the read recognition result editing information data,
wherein the pattern obtaining part obtains the on-line handwritten character pattern using an interface that displays no character frames, and the recognition result editing part edits the recognition result character string using an interface that displays character frames.

2. An on-line handwritten character pattern recognizing and editing apparatus according to claim 1, wherein the recognition result editing information storing part stores a candidate character group with respect to each character of the recognition result character string as the recognition result editing information data.

3. An on-line handwritten character pattern recognizing and editing apparatus according to claim 1, wherein the recognition result editing information storing part stores one or a plurality of character region candidates and a candidate character group with respect to the character region candidates as the recognition result editing information data.

4. An on-line handwritten character pattern recognizing and editing apparatus according to claim 3, wherein the recognition result editing part includes a region for a character displayed as a recognition result with respect to one character frame, and displays, as a recognition candidate, a candidate character in a character cut-out region different from the displayed recognition result.

5. An on-line handwritten character pattern recognizing and editing apparatus according to claim 4, wherein when the candidate character in the character cut-out region different from the displayed recognition result with respect to one character frame is focused, the recognition result editing part discriminates and displays a region in a character frame corresponding to character cut-out of the candidate character.

6. An on-line handwritten character pattern recognizing and editing apparatus according to claim 1, wherein the recognition result editing information storing part stores the on-line handwritten character pattern input by the user as the recognition result editing information data.

7. An on-line handwritten character pattern recognizing and editing apparatus according to claim 2, wherein the recognition result editing information storing part stores the on-line handwritten character pattern input by the user as the recognition result editing information data.

8. An on-line handwritten character pattern recognizing and editing apparatus according to claim 3, wherein the recognition result editing information storing part stores the on-line handwritten character pattern input by the user as the recognition result editing information data.

9. An on-line handwritten character pattern recognizing and editing apparatus according to claim 4, wherein the recognition result editing information storing part stores the on-line handwritten character pattern input by the user as the recognition result editing information data.

10. An on-line handwritten character pattern recognizing and editing apparatus according to claim 5, wherein the recognition result editing information storing part stores the on-line handwritten character pattern input by the user as the recognition result editing information data.

11. An on-line handwritten character pattern recognizing and editing apparatus according to claim 2, wherein the recognition result editing information storing part stores, as the recognition result editing information data, a character division candidate and the on-line handwritten character pattern cut-out corresponding to the character division candidate.

12. An on-line handwritten character pattern recognizing and editing apparatus according to claim 1, further comprising a recognition range selecting part for selecting a range to be recognized in the on-line handwritten character pattern,
wherein the pattern obtaining part obtains the on-line handwritten character pattern in a range selected by the recognition range selecting part.

13. An on-line handwritten character pattern recognizing and editing apparatus according to claim 1, comprising an output region determining part for determining a region for outputting a pattern recognition result based on a region where the on-line handwritten character pattern is input, in place of the output region instruction receiving part.

14. An on-line handwritten character pattern recognizing and editing apparatus according to claim 1, further comprising:
a region information obtaining part for, in a case of receiving an instruction of an output region and an editing region in the output region instruction receiving part and the editing region instruction receiving part, obtaining information peculiar to the output region and the editing region; and
a region information setting part for setting information peculiar to the output region and the editing region obtained in the region information obtaining part with respect to the pattern recognizing part and the recognition result editing part.

15. An on-line handwritten character pattern recognizing and editing method for recognizing an on-line handwritten character pattern input by a user and outputting and editing a recognition result in a specified region, the method comprising:
obtaining the on-line handwritten character pattern;
recognizing the obtained on-line handwritten character pattern, and outputting a recognition result character string and editing information for editing a recognition result;
specifying a region for outputting the recognition result character string;
transmitting the recognition result character string to the specified region for outputting;
storing the editing information as recognition result editing information data on a basis of the specified region for outputting;
specifying a region for editing the recognition result character string;
reading the recognition result editing information data stored in the region for outputting corresponding to the specified region for editing; and
editing the recognition result character string based on the read recognition result editing information data,
wherein, in the process of obtaining the on-line handwritten character pattern, the on-line handwritten character pattern is obtained using an interface that displays no character frames, and in the process of editing the on-line handwritten character pattern, the recognition result character string is edited using an interface that displays character frames.

16. A recording medium storing a computer-executable program for realizing an on-line handwritten character pattern recognizing and editing method for recognizing an on-line handwritten character pattern input by a user and outputting and editing a recognition result in a specified region, the program comprising:
obtaining the on-line handwritten character pattern;
recognizing the obtained on-line handwritten character pattern, and outputting a recognition result character string and editing information for editing a recognition result;
specifying a region for outputting the recognition result character string;
transmitting the recognition result character string to the specified region for outputting;
storing the editing information as recognition result editing information data on a basis of the specified region for outputting;
specifying a region for editing the recognition result character string;
reading the recognition result editing information data stored in the region for outputting corresponding to the specified region for editing; and
editing the recognition result character string based on the read recognition result editing information data,
wherein, in the process of obtaining the on-line handwritten character pattern, the on-line handwritten character pattern is obtained using an interface that displays no character frames, and in the process of editing the on-line handwritten character pattern, the recognition result character string is edited using an interface that displays character frames.
